(19) United States
(12) Patent Application Publication
(10) Pub. No.: US 2011/0050563 A1
(43) Pub. Date: Mar. 3, 2011

(54) METHOD AND SYSTEM FOR A MOTION COMPENSATED INPUT DEVICE

(76) Inventor: Timothy Douglas Skutt, Kentwood, MI (US)

(21) Appl. No.: 12/551,137

(22) Filed: Aug. 31, 2009

(51) Int. Cl. G09G 5/00

(52) U.S. Cl. 345/156

(57) ABSTRACT

A method and system for a motion compensated input device are provided. The motion compensated input device includes an input device configured to receive a physical input from a user and convert the physical input into a physical input signal representative of the physical input, a motion sensing device configured to sense acceleration forces of at least one of the input device and the user, the acceleration forces introducing an error into the physical input, and an input compensator configured to adjust the physical input signal using the acceleration forces to generate a compensated input signal representative of the physical input.

### BACKGROUND OF THE INVENTION

The field of the invention relates generally to human machine interfaces (HMI), and more specifically, to a method and system for a motion compensated human input device.

Human input devices such as joysticks, trackballs, touchpads, and computer mice are vulnerable to erroneous operation when used in high motion environments. This is partly due to the motion's effect on the operator where the motion can induce the operator to provide an input different than the operator's intended input. An example is a scenario where an operator intends to move a joystick right, but due to the environment's motion, the joystick is moved up and right. Another example is a scenario where a user intends to move a computer mouse an inch forward, but due to the environment's motion (e.g., a sudden bump), the mouse is moved three inches forward.

In high motion environments such as an aircraft experiencing turbulence or high-G evasive maneuvers or a ground vehicle traveling on rough terrain, human input devices that provide a continuous input related to the user's position and motion are either avoided or significantly limited in their capabilities. When the input devices are avoided, other, less effective methods of input tend to be used.

### BRIEF DESCRIPTION OF THE INVENTION

In one embodiment, a motion compensated input device includes an input device configured to receive a physical input from a user and convert the physical input into a physical input signal representative of the physical input, a motion sensing device configured to sense acceleration forces of at least one of the input device and the user, the acceleration forces introducing an error into the physical input, and an input compensator configured to adjust the physical input signal using the acceleration forces to generate a compensated input signal representative of the physical input.

In another embodiment, a method of motion compensating an input command includes receiving a physical input from a user using an input device, transforming the physical input into a physical input signal representative of the physical input, determining acceleration forces acting on at least one of the input device and the user, the acceleration forces tending to introduce error into the physical input, and adjusting the physical input signal using the acceleration forces to generate a compensated input signal representative of the physical input.

In yet another embodiment, a control system includes an input device configured to receive a physical input from a user and convert the physical input into a physical input signal representative of the physical input, a multi-axis accelerometer configured to sense acceleration forces of at least one of the input device and the user wherein the acceleration forces introduce error into the physical input. The control system also includes an input compensator configured to adjust the physical input signal using the acceleration forces to generate a compensated input signal representative of the physical input, and a processor communicatively coupled to the input compensator wherein the processor is configured to receive the compensated input signal, generate an output signal using the compensated input signal, and transmit the generated output signal to a controller.

### BRIEF DESCRIPTION OF THE DRAWINGS

FIGS. 1 and 2 show exemplary embodiments of the method and system described herein.

FIG. 1 is a schematic block diagram of a control system including a motion compensated input device in accordance with an exemplary embodiment of the present invention;

FIG. 2 is graph of an exemplary physical input signal shown in FIG. 1 that may be used with control system 100 also shown in FIG. 1.

### DETAILED DESCRIPTION OF THE INVENTION

The following detailed description illustrates embodiments of the invention by way of example and not by way of limitation. It is contemplated that the invention has general application to inputting human generated commands into control systems in environments where motion in the environment introduces an error in the input command in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

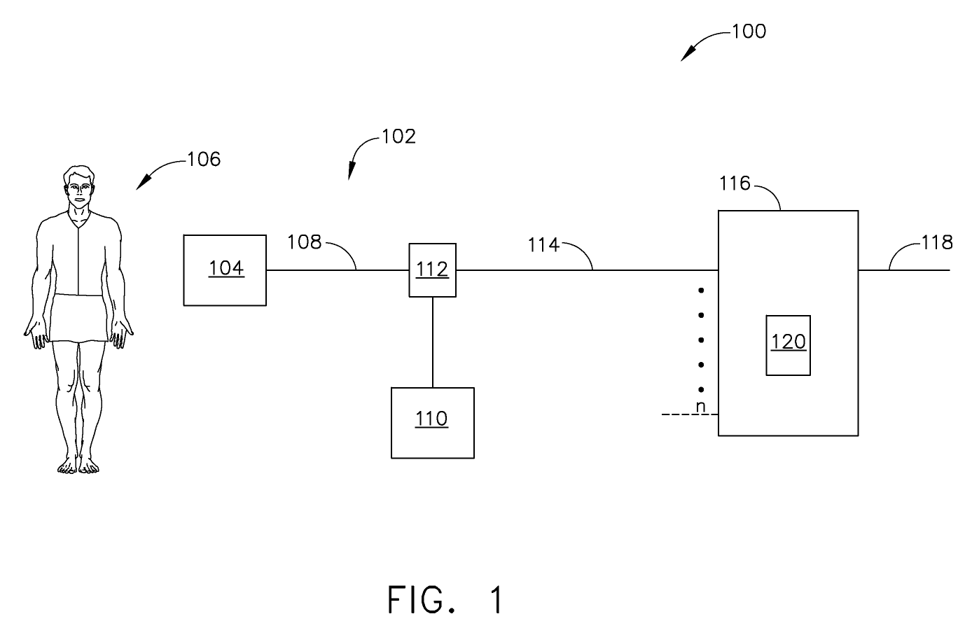

FIG. 1 is a schematic block diagram of a control system 100 including a motion compensated input device 102 in accordance with an exemplary embodiment of the present invention. In the exemplary embodiment, control system 100 includes an input device 104 is configured to receive a physical input from a user 106 and convert the physical input into a physical input signal 108 representative of the physical input. Control system 100 also includes a motion sensing device 110 configured to sense acceleration forces of at least one of input device 104 and user 106 wherein the acceleration forces introduce an error into the physical input. Control system 100 also includes an input compensator 112 configured to adjust physical input signal 108 using the acceleration forces to generate a compensated input signal 114 representative of the physical input. A plurality of input signals 114 may be transmitted to a controller 116 that is configured to use the plurality of input signals 114 directly or may further process the plurality of input signals 114 to generate one or more output signals 118 that are used to control various systems onboard the vehicle. In the exemplary embodiment, controller 116 includes a processor 120 programmed to receive the plurality of input signals 114 for further processing and/or transmission to other vehicle systems. In addition to processor 120, components of motion compensated input device 102 such as input device 104, motion sensing device 110, and input compensator 112 may include separate processors or may be controlled through processor 120.

As used herein, a physical input refers to for example, but not limited to, a bodily movement or a sensed change in position, orientation, electrical activity, or expression. For example, in one embodiment, input device 104 comprises a gestural interface configured to receive the physical input using an image of the user. Using the image, facial or other features of user 106 are used to determine the physical input. In another embodiment, input device 104 comprises a proximity interface configured to detect a presence of at least a portion of the body of user 106 and to monitor a relative location of the portion of the user's body. In the exemplary embodiment, the proximity interface is able to monitor a relative location of the portion of the user's body in three dimensions. In a further embodiment, input device 104 comprises a manual interface configured to be physically manipulated by at least a portion of the user's body. The manual interface may be, but is not limited to, a mouse, joystick, trackball, or touch screen.

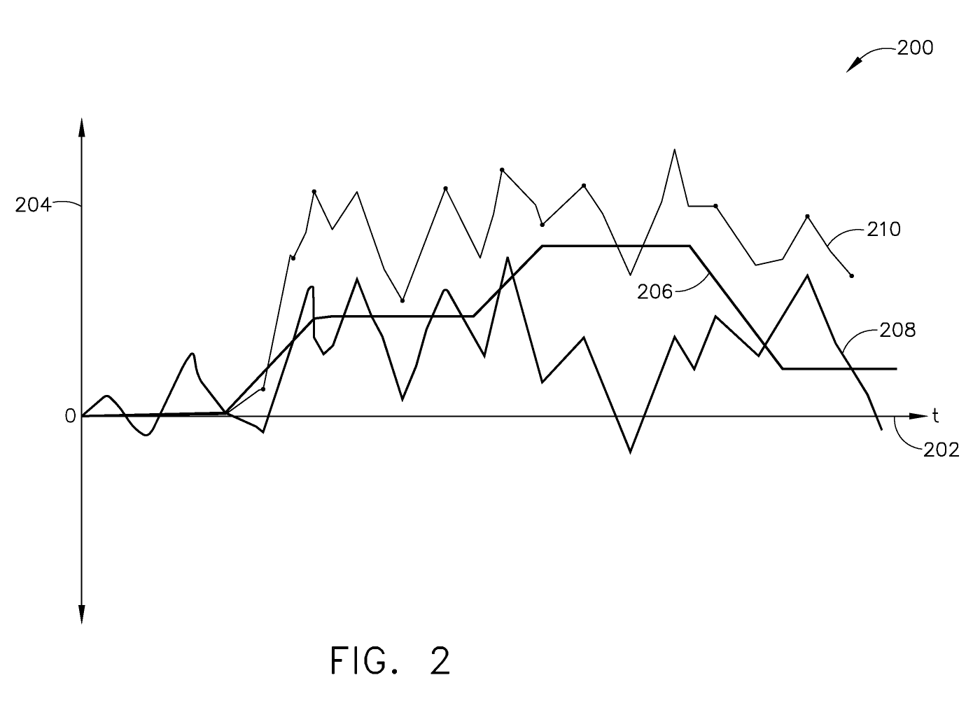

FIG. 2 is graph 200 of an exemplary physical input signal 108 (shown in FIG. 1) that may be used with control system 100 (also shown in FIG. 1). In the exemplary embodiment, graph 200 includes an x-axis 202 graduated in units of time and a y-axis 204 indicating a relative magnitude and direction of input signals. Graph 200 includes a trace 206 of a physical input to input device 104, a trace 208 representing an exemplary environmental motion of input device 104 and/or user 106, and a trace 210 representing physical input signal 108. Because of the motion of user 106 and/or input device 104 while user 106 is applying a desired physical input to input device 104, physical input signal 108 comprises two components, a desired input component representative of an input desired to be input by the user, which is represented by trace 206 and an error component representative of a motion of input device 104 and/or user 106, which is represented by trace 208.

During operation, motion sensing device 110, for example, a multi-axis or tri-axial accelerometer is positioned to measure the motion of input device 104 and/or user 106. In various embodiments, control system 100 includes a plurality of motion sensing devices 110 positioned to measure the motion of input device 104 and/or user 106 separately or as an array. Additionally, the plurality of motion sensing devices 1 10 may be communicatively coupled to control system 100 for redundancy and such that the effects of component failures are reduced. Motion sensing device 110 is communicatively coupled to input compensator 112, which is also communicatively coupled to input device 104. In one embodiment, input compensator 112 is configured to adjust the physical input signal to substantially cancel the error component using the acceleration forces. In another embodiment, input compensator 112 is configured to scale the physical input signal to facilitate reducing the error component in relation to the desired input component using the acceleration forces. In various embodiments, an electronic model of input device 104 and/or user 106 may be stored in a memory associated with processor wherein said input compensator configured to adjust the physical input signal using the model and the acceleration forces.

As described above, various embodiments of the present invention permit coupling a human input device with a motion sensing device such as a multi-axis accelerometer to adjust the input presented by human input device. Several methods of input adjustment are used. One input adjustment is to scale the input based on the amount of motion in the environment. Another input adjustment is to compensate the input using the measured motion and a model of the input system (device, operator's hand, etc.) so that the motion's impact on the input system is subtracted from the input. Such motion compensation permits an expanded variety of input devices available to cockpit/operator station designers and system integrators. Embodiments of the present invention permit the use of commonly available human input devices that are not currently used in high motion environments due to motion induced errors.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 120, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is permitting coupling of a human input device with a motion sensing device such as a multi-axis accelerometer to adjust the input presented by human input device wherein several methods of input adjustment are used. One input adjustment is to scale the input based on the amount of motion in the environment. Another input adjustment is to compensate the input using the measured motion and a model of the input system (device, operator's hand, etc.) so that the motion's impact on the input system is subtracted from the input. Such motion compensation permits the use of commonly available human input devices that are not currently used in high motion environments due to motion induced errors. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and systems for a motion compensated input device provides a cost-effective and reliable means for expanding the variety of input devices available for use in areas such as cockpits and operator stations. More specifically, the method and systems described herein facilitate the use of commonly available human input devices that are not currently used in high motion environments due to motion induced errors. As a result, the method and systems described herein facilitate operation of vehicles subject to high gravitational forces (High-G), turbulence, jarring surfaces, and/or vibration environments in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A motion compensated input device comprising:
an input device configured to receive a physical input from a user and convert the physical input into a physical input signal representative of the physical input;
a motion sensing device configured to sense acceleration forces of at least one of the input device and the user, the acceleration forces introducing an error into the physical input; and
an input compensator configured to adjust the physical input signal using the acceleration forces to generate a compensated input signal representative of the physical input.

2. A device in accordance with claim 1, wherein said input device comprises a gestural interface configured to receive the physical input using an image of the user.

3. A device in accordance with claim 1, wherein said input device comprises a proximity interface configured to detect a presence of at least a portion of the user's body and to monitor a relative location of the portion of the user's body.

4. A device in accordance with claim 1, wherein said input device comprises a manual interface configured to be physically manipulated by at least a portion of the user's body.

5. A device in accordance with claim 1, wherein said physical input signal comprises a desired input component representative of an input desired to be input by the user and an error component representative of a motion of the at least one of the input device and the user.

6. A device in accordance with claim 5, wherein said input compensator is configured to adjust the physical input signal to substantially cancel the error component using the acceleration forces.

7. A device in accordance with claim 5, wherein said input compensator is configured to scale the physical input signal to facilitate reducing the error component in relation to the desired input component using the acceleration forces.

8. A device in accordance with claim 1, further comprising an electronic model of at least one of said input device and said user wherein said input compensator configured to adjust the physical input signal using the model and the acceleration forces.

9. A device in accordance with claim 1, wherein said motion sensing device comprises a multi-axis accelerometer.

10. A method of motion compensating an input command comprising:
receiving a physical input from a user using an input device;
transforming the physical input into a physical input signal representative of the physical input;
determining acceleration forces acting on at least one of the input device and the user, the acceleration forces tending to introduce error into the physical input; and
adjusting the physical input signal using the acceleration forces to generate a compensated input signal representative of the physical input.

11. A method in accordance with claim 10 wherein determining acceleration forces comprises determining acceleration forces using a multi-axis accelerometer.

12. A method in accordance with claim 10 wherein adjusting the physical input signal comprises combining the received physical input signal and the determined acceleration forces using an input compensator.

13. A method in accordance with claim 10 wherein receiving a physical input from a user using an input device comprises receiving a physical input from a user using at least one of a gestural interface configured to receive the physical input using an image of the user, a proximity interface configured to detect a presence of at least a portion of the user's body and to monitor a relative location of the portion of the user's body, and a manual interface configured to be physically manipulated by at least a portion of the user's body.

14. A control system comprising:
an input device configured to receive a physical input from a user and convert the physical input into a physical input signal representative of the physical input;
a multi-axis accelerometer configured to sense acceleration forces of at least one of the input device and the user, the acceleration forces tending to introduce error into the physical input;
an input compensator configured to adjust the physical input signal using the acceleration forces to generate a compensated input signal representative of the physical input; and
a processor communicatively coupled to said input compensator, said processor configured to:
receive the compensated input signal;
generate an output signal using the compensated input signal; and
transmit said generated output signal to a controller.

15. A device in accordance with claim 14, wherein said input device comprises a gestural interface configured to receive the physical input using an image of the user.

16. A device in accordance with claim 14, wherein said input device comprises a proximity interface configured to detect a presence of at least a portion of the user's body and to monitor a relative location of the portion of the user's body.

17. A device in accordance with claim 14, wherein said input device comprises a manual interface configured to be physically manipulated by at least a portion of the user's body.

18. A device in accordance with claim 14, wherein said physical input signal comprises a desired input component representative of an input desired to be input by the user and an error component representative of a motion of the at least one of the input device and the user.

19. A device in accordance with claim 18, wherein said input compensator is configured to adjust the physical input signal to substantially cancel the error component using the acceleration forces.

20. A device in accordance with claim 18, wherein said input compensator is configured to scale the physical input signal to facilitate reducing the error component in relation to the desired input component using the acceleration forces.
